(19) United States
(12) Patent Application Publication
(10) Pub. No.: US 2011/0036012 A1
(43) Pub. Date: Feb. 17, 2011

(54) METHOD FOR PREREFORMING ETHANOL

(75) Inventors: Stephan Hatscher, Syke (DE); Thorsten von Fehren, Burstadt (DE); Markus Hölzle, Kirchheim (DE)

Correspondence Address: CONNOLLY BOVE LODGE & HUTZ, LLP, P O BOX 2207, WILMINGTON, DE, 19899, US

(73) Assignee: BASF SE, Carl-Bosch-Strasse:GVX-C006 (DE)

(21) Appl. No.: 12/988,727

(22) PCT Filed: Apr. 21, 2009
(86) PCT No.: PCT/EP2009/054704

§ 371 Date: Oct. 21, 2010

(30) Foreign Application Priority Data
Apr. 22, 2008 (EP) 08154928.9

(51) Int. Cl. C10L 3/00; B01J 23/10

(52) U.S. Cl. 48/197 FM; 502/304

(57) ABSTRACT

In a process for cleaving ethanol into C₁ units in a prereformer ethanol and steam are converted at a temperature in the range from 300 to 550° C. over a catalyst which comprises platinum on a support comprising a mixture of ZrO₂ and CeO₂.

The invention relates to a process for cleaving ethanol into C₁ units in a prereformer and to a catalyst suitable therefor.

Fuel cells (FCs) allow an efficient and environmentally friendly conversion of chemical to electrical energy. Owing to the direct conversion, a high electrical efficiency coupled with low emissions is achieved. Fuel cells possess the potential of becoming a significant future technology both in stationary power generation (as a combined heat and power plant) and in mobile (in transport) or portable power generation (as a replacement for modern-day batteries). The fuel cell constitutes a special form of a galvanic element. The electrical energy is obtained by the chemical reaction of hydrogen with oxygen to give water, the cell working without noise and without mechanical wear. The fuels here do not directly form part of the cell and can be supplied continuously. According to the fuel cell type, it is also possible to convert fossil and renewable fuels such as natural gas, biogas or methanol. Depending on the fuel cell type, various demands are made on the purity of the fuel used. The polymer electrolyte membrane fuel cell (PEMFC) is very much more sensitive to impurities than, for example, the molten carbonate fuel cell (MCFC) or solid oxide fuel cell (SOFC). The best efficiencies are achieved in the case of operation with pure hydrogen. To use other fuels (propane, butane, gasoline, etc.) in fuel cells, reformers are needed, which convert the particular fuel to a hydrogen-rich gas mixture. In all fuel cell types including the high-temperature fuel cell, the temperature is sufficiently low that no significant concentrations, for example, of NOₓ arise.

The fuel cell consists of the fuel electrode (anode), the electrolyte and the air-oxygen electrode (cathode). The different fuel cells can be divided into various types. The division can be made either by virtue of the different electrolytes (melt, polymer membrane or solid oxide) or else through the different operating temperatures (low, medium or high temperature) of the fuel cells. In the range of lower performances, the low-temperature fuel cells are dominant, which also include the hydrogen-operated PEMFC.

In the alkaline fuel cell, it is necessary to use air without carbon dioxide or pure oxygen. In addition, the water formed must be removed constantly. The PEMFC, “Direct Methanol Fuel Cell” (DMFC) and “Phosphoric Acid Fuel Cell” (PAFC) are based on the transport of protons through an acid electrolyte. The SOFC and MCFC require high temperatures in order to achieve a sufficient ion conductivity of the solid electrolyte. In addition, the high working temperature of 650° C. in the MCFC enables, as well as power and heat production, also the raising of steam. This can either drive a downstream steam turbine, which increases the electrical efficiency, or may be used directly in industrial plants as process steam. Owing to the high working temperature in the cell, natural gas can be reformed to hydrogen and carbon dioxide internally. No external reformer is needed. The high temperatures and the aggressive liquid salts (alkali metal carbonates) of the electrolyte make high demands on the material.

The MCFC is operated within a temperature range which enables partial reforming of methane in the presence of a suitable catalyst. A distinction is drawn here between direct internal reforming (DIR) and indirect internal reforming (IIR). In the case of DIR, the reforming catalyst is present in the anode chamber, whereas it is arranged between the cells in the stack in the case of IIR. In the example of an Ni-based catalyst, it would be poisoned rapidly in the case of DIR in an MCFC through the contact with the carbonate-containing electrolyte. By virtue of the different arrangement in the IIR, this direct contact is avoided and hence the lifetime of the catalyst is increased considerably. In addition, the waste heat generated in the MCFC can be utilized by the internal reforming process and the efficiency of the fuel cell can be increased.

The metal-catalyzed steam reforming of ethanol in the preparation of hydrogen for fuel cell applications is described, for example, in Applied Catalysis B: Environmetal 39 (2002), pages 65 to 74. Different active metals such as rhodium, palladium, nickel and platinum on different supports such as cerium oxide/zirconium dioxide supports have been studied in the steam reforming of ethanol/water mixtures to prepare hydrogen. As an alternative support, aluminum oxide was used. In the case of use of cerium oxide/zirconium dioxide-supported catalysts, no formation of ethene was observed. The catalyst used comprises 1% Pt/Ce₂O₃/ZrO₂, but the support is not defined in detail.

Prepr. Pap. Am. Chem. Soc., Div. Fuel Chem. 2004, 49 (2), pages 912 to 913 describes hydrogen production from biomass. This conversion is effected by catalytic steam reforming. One catalyst described comprises 3% Pt, 3% Rh on Ce₂O₃—ZrO₂. An exact composition of the support is not specified.

Applied Catalysis b: Environmental 61 (2005), pages 130 to 139 describes the steam reforming of model compounds and the rapid pyrolysis of biogenic oil on supported noble metal catalysts. In addition to other noble metals, platinum is also used, the supports used being aluminum oxide and cerium oxide/zirconium dioxide. In addition to other model compounds, ethanol was also used. It is stated that the use of cerium oxide-zirconium dioxide in the form of a redox mixed oxide led to higher hydrogen yields compared to catalyst supported on aluminum oxide. There are reports of carbon deposits in the quartz glass reactor. One catalyst used for the steam reformation comprises 1% Pt on a Ce₂O₃ZrO₂ not stipulated in detail as a support, with which, for example, ethanol is converted to synthesis gas and CO₂ without formation of methane.

If ethanol is to be used as a fuel for a fuel cell, especially a molten carbonate fuel cell (MCFC), the ethanol must first be cleaved in a prereformer, so as to obtain combustion gas comprising C₁ units such as methane, CO and CO₂, which is supplied to the fuel cell. The catalyst used should simultaneously be selective, in order to prevent the formation of by-products such as acetaldehyde, ethene or the like, which might damage the fuel cell, especially the molten carbonate fuel cell. In addition, it is advantageous to use a catalyst which ensures functioning at temperatures below 450° C., in order to enable a maximum overall efficiency of the system. In addition, operation at a low S/C ratio (steam/carbon ratio) should advantageously be possible, in order to enable economically viable operation.

It is an object of the present invention to provide a catalyst and a process for cleaving ethanol into C₁ units in a prereformer, the above requirements being met.

The object is achieved in accordance with the invention by a process for cleaving ethanol into C₁ units in a prereformer, in which ethanol and steam are converted at a temperature in the range from 300 to 550° C. over a catalyst which comprises platinum on a support comprising a mixture of ZrO₂ and CeO₂.

“C₁ units” are understood to mean molecules which arise through cleavage of the carbon-carbon bond in ethanol. The principle C₁ units formed are methane, CO and CO₂. These C₁ units differ, for example, from C₂ compounds formed as by-products in the cleavage, such as acetaldehyde and ethene, or solid carbon formed, which can inactivate the catalyst as a result of deposit formation and whose formation therefore has to be prevented.

The prereformer may, for example, be a steam prereformer.

The use of platinum as an active metal makes a reduction of the catalyst, as necessary, for example, in the case of nickel, superfluous, such that a corresponding risk potential is avoided and the startup of the reaction is simplified. Low platinum contents allow economic catalyst preparation.

In the cleavage of ethanol in the prereformer, ethanol is reacted with water to give methane, carbon monoxide, carbon dioxide and hydrogen. Carbon monoxide can in turn be reacted with water to give carbon dioxide and hydrogen. The direct dehydration of ethanol to ethene and water should very substantially be prevented, just like the formation of carbon.

It has been found in accordance with the invention that a catalyst which comprises platinum on a support comprising a mixture of ZrO₂ and CeO₂ is particularly suitable for steam prereforming of ethanol.

Preference is given to using ZrO₂ and CeO₂ in the form of a mixed powder or of a coprecipitate, such that no specific mixed oxide or redox mixed oxide is present, but rather ZrO₂ and CeO₂ alongside one another, in contrast to, for example, the cited reference from Applied Catalysis b, according to which a mixed oxide is obviously used.

In one embodiment of the invention, the catalyst comprises preferably from 0.1 to 5% by weight of platinum, based on the overall catalyst, and the weight ratio of CeO₂ to ZrO₂ is from 1:2 to 1:7.

The amount of platinum is more preferably from 0.15 to 1% by weight, especially from 0.2 to 0.5% by weight, especially about 0.25% by weight. The weight ratio of CeO₂ to ZrO₂ is more preferably from 1:3 to 1:6, especially from 1:4 to 1:5, especially about 1:4.5.

In another embodiment of the invention, the amount of platinum is preferably from 0.1 to 0.5% by weight, more preferably from 0.15 to 0.5% by weight, especially from 0.2 to 0.5% by weight, based on the total weight of the catalyst.

In this case, the weight ratio of CeO₂ to ZrO₂ can generally be selected freely. Preferably, a weight ratio of CeO₂ to ZrO₂ as described above is present.

The catalyst may comprise exclusively ZrO₂ and CeO₂ as the support material. In addition, the catalyst may comprise exclusively platinum as the active metal, such that it consists of platinum, ZrO₂ and CeO₂, apart from assistance.

The catalyst has preferably been doped with from 0.01 to 10% by weight, more preferably from 1 to 8% by weight, especially from 3 to 6% by weight, based on the total weight of the catalyst, of at least one rare earth metal oxide. The rare earth metal is preferably lanthanum, yttrium or praseodymium. It is more preferably lanthanum.

When the catalyst is subjected to shaping, for example by extrusion or tableting, the catalyst preferably additionally comprises from 3 to 20% by weight, more preferably from 5 to 15% by weight, especially from 7 to 12% by weight, based on the total weight of the catalyst, of Al₂O₃.

The BET surface area of the oxidic powder used to prepare the support is preferably from 50 to 150 m²/g, more preferably from 70 to 110 m²/g. In the case of addition of Al₂O₃, the BET surface area is preferably increased by about 10 m²/g. The total area of the pores in the finished catalyst is preferably from 60 to 120 m²/g, more preferably from 70 to 110 m²/g, especially from 80 to 95 m²/g.

In addition to the metal oxides mentioned, it is possible for further metal oxides to be present as additives in the catalyst support, for example alkali metal oxides and metal oxides of group VIII of the Periodic Table of the Elements, especially iron oxide.

The catalyst can be prepared by any suitable processes, which can be selected according to the desired shaping. The catalyst support can be prepared, for example, by coprecipitation from a solution. Alternatively, it can be prepared by kneading the oxides of the catalyst support, which is followed by shaping, drying and calcining. The active metals, especially platinum, can be applied in the form of an aqueous salt solution before or after the preparation of the catalyst support. For example, a finished catalyst support can be impregnated with a platinum salt solution, dried and calcined. It is also possible to add an aqueous platinum salt solution before the kneading.

In general, the catalyst is prepared by kneading CeO₂, ZrO₂, optionally Al₂O₃ and, if present, rare earth metal oxide with addition of water, and subsequently shaping, drying and calcining, an aqueous platinum salt solution being added before the kneading or applied after the drying.

In the process according to the invention, the catalyst can be used in any suitable form, for example in the form of powders, spall, granules, pellets, tablets or extrudates. Preference is given to using the catalyst in extrudate form as a fixed bed.

The process for reforming ethanol can be performed continuously or batchwise. It is preferably performed continuously.

The gas mixture obtained can be fed to a reformer, in which case it is also possible for prereforming and reforming to be provided as apparatus units connected to one another. Preference is given to further conversion in a fuel cell, especially a molten carbonate fuel cell (MCFC).

The reaction is performed at a temperature in the range from 300 to 550° C., preferably at from 350 to 525° C., especially at from 400 to 500° C. The pressure can be selected freely. The absolute pressure is frequently from 0.5 to 20 bar, preferably from 0.8 to 2.0 bar, especially from 1.2 to 1.5 bar.

The molar S/C ratio of steam to carbon atoms in the prereformer is preferably in the range from 1.8 to 5.9, more preferably from 2.0 to 4.0, especially from 2.2 to 3.0.

The GHSV (Gas Hourly Space Velocity) is frequently from 500 to 10 000 h⁻¹, preferably not more than 4500 h⁻¹ and not less than 2000 h⁻¹. The upper limit is more preferably 4000 h⁻¹, particularly preferably 3000 h⁻¹, especially preferably 2500 h⁻¹.

Ethanol can be used in the process in any suitable form. In addition to pure ethanol, it is possible to use bioethanol, and likewise ethanol/methanol mixtures which may additionally comprise water in small amounts. Small amounts of formic acid and aldehydes can be tolerated, though these compounds are preferably absent. The proportion of methanol, based on the alcohols in the mixture, is preferably not more than 20% by weight, more preferably not more than 10% by weight.

The gas mixture obtained from the prereformer comprises preferably, at an S/C value of from 2.5 to 3.0, from 5 to 45% by volume of hydrogen, from 0 to 80% by volume of nitrogen, from 0 to 3% by volume of carbon monoxide, from 2 to 25% by volume of methane, from 2 to 25% by volume of carbon dioxide, where the total amount adds up to 100% by volume.

The invention is illustrated in detail by the examples which follow.

### EXAMPLES

### Catalyst Preparation

### Preparation Example 1

First, 100 g of a mixture of 12% by weight of CeO₂ and 72% by weight of ZrO₂, and also 10% by weight of aluminum oxide (Pural® SB) and 6% by weight of La₂O₃, are initially charged in a kneader and acidified with dilute nitric acid (4.1 g of 14% by weight HNO₃). The mixture was then shaped, if appropriate with addition of further water.

Then it was extruded to form extrudates with a diameter of 1.5 mm, dried at 200° C. for 4 hours and then calcined at 500° C. for 2 hours.

The impregnation with the desired amount of a 12.9% by weight platinum nitrate solution is effected in an impregnating drum using a spray nozzle. The extrudates are initially charged in the impregnating drum and sprayed with the platinum nitrate solution while stirring. This is followed by drying at 200° C. for 4 hours and then calcining at 500° C. for 2 hours.

The resulting catalyst has a bulk density of 1093 g/l.

### Preparation Example 2

In an alternative preparation, the CeO₂/ZrO₂/La₂O₃ powder (80% by weight of ZrO₂, 13% by weight of CeO₂, 7% by weight of La₂O₃) in an amount of 1289.3 g is initially charged in a kneader together with 183.65 g of Al₂O₃ (Pural® SB). Dilute nitric acid and water are then added, as are 26.6 g of (12.9% by weight) platinum nitrate solution. A total of 59.5 g of 65% HNO₃ were added. The total amount of water added was 530 ml. Kneading was effected for 10 minutes and a sufficient amount of water was added as to form a plastic material. The plastic material was shaped to 1.5 mm diameter extrudates on an extrudate press at a pressure of from 85 to 95 bar after a preceding kneading time of 80 minutes.

This was followed by drying in a forced-air drying cabinet at 200° C. for 4 hours and calcinations in a muffle furnace at 500° C. for 2 hours.

The resulting catalyst has a bulk density of 1120 g/l. Alternatively, it if first possible to knead CeO₂/ZrO₂/La₂O₃ with Al₂O₃, and to introduce Pt salt and HNO₃ into the kneading. This is followed by extrusion, drying and calcinations. It is also possible to apply the Pt salt to the support by impregnation.

### Use Examples

### General Procedure

For the experiment, a heated tubular reactor with a diameter of 32 mm was used.

60 ml of the catalyst from example 2 were installed into the reactor. Subsequently, the catalyst was covered with a layer of quartz wool (approx. 10 to 15 ml). At the start of the test, the reactor was brought to the start temperature (see table) and a pressure of 2.5 bar absolute under nitrogen (100 l (STP)/h).

The preheating temperature of the feed was set to from 300° C. to 500° C. When the start temperature (between 450 and 550° C.) of the reactor had been attained, the nitrogen supply was closed and the metered addition of water was started. After a further 5 min., the experiment was started up by the start of metered addition of ethanol. The GHSV was 2500 h⁻¹ at an S/C ratio of from 2.5 to 3.0. The experimental data were evaluated with the aid of the GC offgas data from the reactor and the measurement data from the Dasylab Data Recording Software (Version 5.6).

The catalysts were analyzed under the conditions specified.

| | | | | | | Carbon | | Carbon |
|---|---|---|---|---|---|---|---|---|
| | Preheating | Reactor | Reactor | Hydrogen | Nitrogen | monoxide | Methane | dioxide |
| S/C | temperature | inlet | outlet | [% by vol.] | [% by vol.] | [% by vol.] | [% by vol.] | [% by vol.] |
| 2.50 | 500° C. | 550° C. | 291° C. | 11.98 | 64.65 | 0.61 | 6.10 | 5.74 |
| 2.75 | 300° C. | 470° C. | 248° C. | 10.08 | 68.28 | 0.60 | 5.28 | 4.78 |
| 2.75 | 300° C. | 480° C. | 251° C. | 11.39 | 66.14 | 0.49 | 5.88 | 5.53 |
| 2.75 | 300° C. | 500° C. | 264° C. | 12.23 | 64.30 | 0.53 | 6.34 | 5.90 |
| 2.75 | 320° C. | 520° C. | 229° C. | 11.21 | 66.38 | 0.59 | 5.84 | 5.33 |

1.-9. (canceled)

10. A process for cleaving ethanol into C₁ units in a prereformer, which comprises converting ethanol and steam at a temperature in the range from 300 to 550° C. over a catalyst which comprises platinum on a support comprising a mixture of ZrO₂ and CeO₂ and has been doped with from 0.01 to 10% by weight, based on the total weight of the catalyst, of at least one rare earth metal oxide and can additionally comprise from 3 to 20% by weight, based on the total weight of the catalyst, of Al₂O₃.

11. The process according to claim 10, wherein ZrO₂ and CeO₂ are used in the form of a mixed powder or of a co-precipitate.

12. The process according to claim 10, wherein the molar S/C ratio of steam to carbon atoms in the prereformer is in the range from 1.8 to 5.0.

13. The process according to claim 11, wherein the molar S/C ratio of steam to carbon atoms in the prereformer is in the range from 1.8 to 5.0.

14. The process according to claim 10, wherein the amount of platinum is from 0.1 to 5% by weight, based on the overall catalyst, and the weight ratio of CeO₂ to ZrO₂ is from 1:2 to 1:7.

15. The process according to claim 13, wherein the amount of platinum is from 0.1 to 5% by weight, based on the overall catalyst, and the weight ratio of CeO₂ to ZrO₂ is from 1:2 to 1:7.

16. The process according to claim 10, wherein the amount of platinum is from 0.1 to 0.5% by weight, based on the total weight of the catalyst.

17. The process according to claim 15, wherein the amount of platinum is from 0.1 to 0.5% by weight, based on the total weight of the catalyst.

18. A catalyst which comprises platinum on a support comprising a mixture of ZrO₂ and CeO₂ and has been doped with from 0.01 to 10% by weight, based on the total weight of the catalyst, of at least one rare earth metal oxide and can additionally comprise from 3 to 20% by weight, based on the total weight of the catalyst, of Al₂O₃.

19. A process for preparing the catalyst according to claim 18 which comprise kneading CeO₂, ZrO₂, rare earth metal oxide and optionally Al₂O₃ with addition of water, and subsequently shaping, drying and calcining, an aqueous platinum salt solution being added before the kneading or applied after the drying.
